(19) United States
(12) Patent Application Publication
(10) Pub. No.: US 2003/0071737 A1
(43) Pub. Date: Apr. 17, 2003

(54) Automated stormwater monitoring system and method

(76) Inventor: Dilip Nawathe, Lilburn, GA (US)

Correspondence Address: Robert B. Kennedy, Baker, Donelson, Bearman & Caldwell, Suite 900, Five Concourse Parkway, Atlanta, GA, 30328, US

(21) Appl. No.: 09/977,976

(22) Filed: Oct. 16, 2001

(51) Int. Cl. G08B 21/00

(52) U.S. Cl. 340/616; 340/602

(57) ABSTRACT

Stormwater running at a construction site is monitored from an off-site location. When rainfall of a selected level is detected on site, a specimen of runoff is collected and an offsite station signaled that the event has occurred.

### TECHNICAL FIELD

This invention relates to the monitoring of stormwater run off at construction sites and other applications including effluent monitoring of wastewater treatment systems.

### BACKGROUND OF THE INVENTION

Construction sites almost invariably strip and recontour land which can result in unnatural soil erosion under heavy rain conditions. Because of this governmental regulations often require that such sites be monitored. This involves the monitoring of rainfall and the collection of soil wash or runoff for analysis. Collected samples are tested for such things as turbidity or particle concentration, and other pollutents.

To this end stormwater or soil wash monitoring apparatuses have heretofore been developed and used at construction sites. The apparatus has included rain gauges and runoff samplers that are made to operate in response to a certain amount of rain having been detected to have fallen on a site during a selected time interval. After a heavy rain has fallen a worker at the site collects a runoff specimen which for later off-site analysis. If no worker is at the site, one is dispatched to it to do this within a certain time frame.

Compliance with soil runoff monitoring rules has been found to be quite costly. Such may be not particularly burdensome when done during the course of a workday. At other times, however, the cost is substantial. For example, having to dispatch a worker in the middle of the night to a site is obviously expensive. Having to dispatch one needlessly is even more costly. That often happens when a worker is dispatched only for him to find on his arrival that only a light rain or even no rain has actually fallen at the site. Moreover, large sites typically require that stormwater runoff be collected at several different collection points which further increases the burden of compliance.

Accordingly, it seems that a need exists for an automated stormwater monitoring system that alleviates much of the just described problems. It thus is to the provisions of such that the present invention is primarily directed.

### SUMMARY OF THE INVENTION

In a preferred form of the invention an automated stormwater monitoring system comprises means for detecting on-site rainfall at a construction site. The system also has means for collecting a specimen of rainfall runoff in response to the detection of a selected leave of on-site rainfall. The system further has means for signaling an offsite station that an event has occurred. That signaled event may be that a certain amount of rain has fallen or that a specimen has been collected, or both. This enables the offsite station to dispatch a courier to the site to collect the specimen for analysis.

Where the construction site is large the monitoring system further has means for generating an on-site master activate signal in response to the detection of the selected level of onsite rainfall, and one or more slave units that have a slave radio receiver and means for collecting a specimen of rainfall runoff in the environ of the slave unit in response to the receipt of a master radio signal by the salve radio receiver.

In another form of the invention a method of monitoring stormwater runoff at a construction site comprises the steps of detecting rainfall on site at the construction site and collecting a specimen of stormwater runoff at the construction site in response to the detection of rainfall of a selected amount. An off-site monitoring station is then signaled that a monitoring event has occurred at the construction site.

### BRIEF DESCRIPTION OF THE DRAWING

FIG. 1 is a block diagram of a preferred embodiment of the automated stormwater monitoring system.

FIG. 2 is a block diagram of a preferred embodiment of the slave unit.

FIGS. 3-7 are flow diagrams of the software operations executed by the system computer.

### DETAILED DESCRIPTION

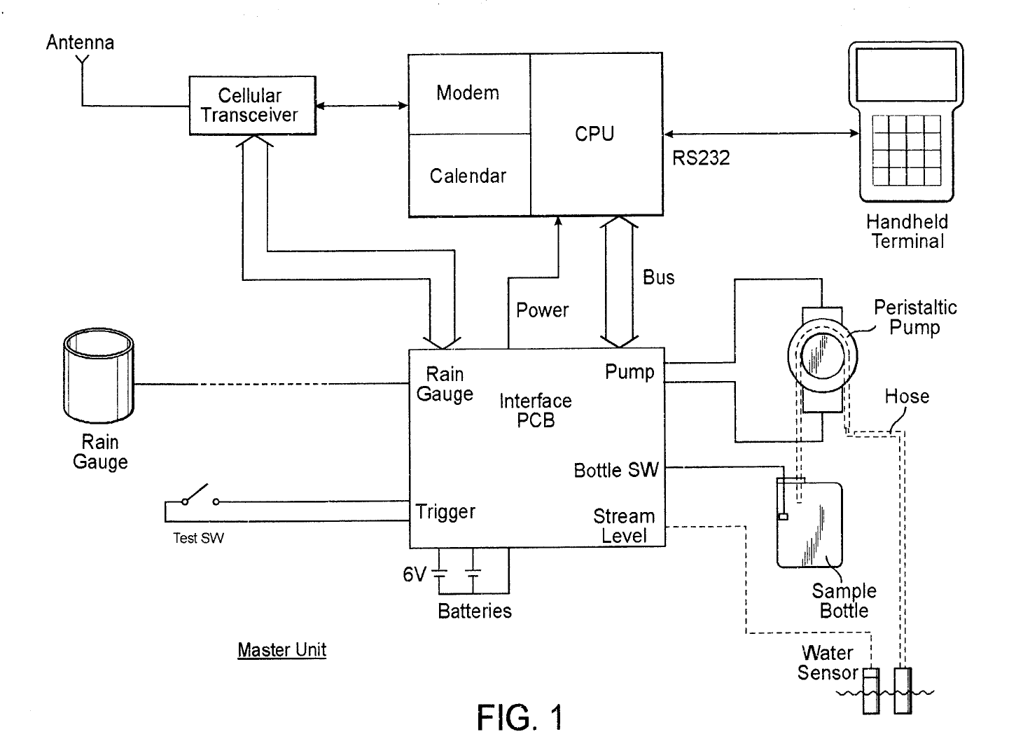

With reference in more detail to the drawing there is shown in FIG. 1 an automated stormwater monitoring system that comprises a computer central processing unit or CPU which may be a Siemens 80C535 microprocessor. A modem and calendar are coupled with the CPU. The modem may be a Rockwell Model RC224ATF. The calendar comprises a clock, memory and a D.C. power source such as that offered by Dallas Semiconductor. The modem is coupled with a cellular transceiver which is also coupled with an interface printed circuit board. Power is supplied by batteries to the interface board and in turn to the CPU and cellular transceiver. A terminal is coupled with the CPU that has a keyboard in order to enter setting into the system.

The mechanical units operated by the computer are electrically connected with the Interface. This includes a rain gauge. The rain gauge is preferably a self emptying type that tips, for example, each time that 1/10 inch of water has been collected. For example after 50 tip signals have been sent to the interface from the rain gauge, system activation is made since that equals one-half inch of detected rainfall. This, of course, is just an example for one setting entered from the terminal. A peristaltic pump is connected through an unshown relay with the interface. A hose extends from the pump to a collector located in a stormwater runoff bed on the construction site. A water sensor is also located there which is electrically connected to the Interface. A hose extends from the pump to a sample or specimen bottle. A water sensor is mounted to sense a water level in the bottle which is connected to the interface board.

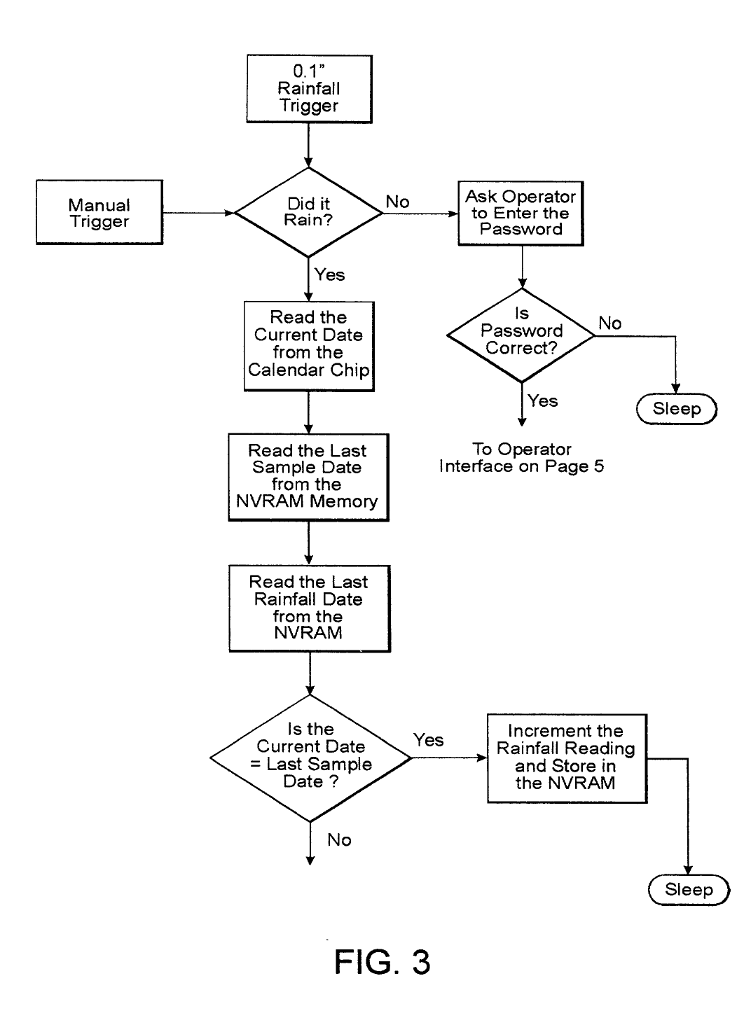

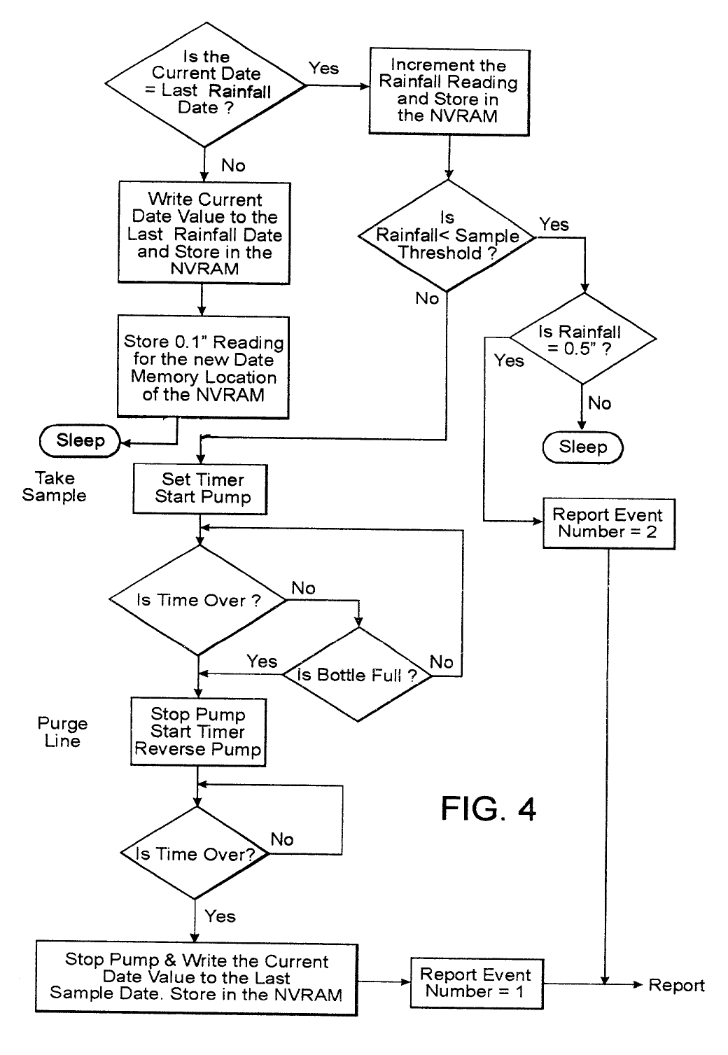

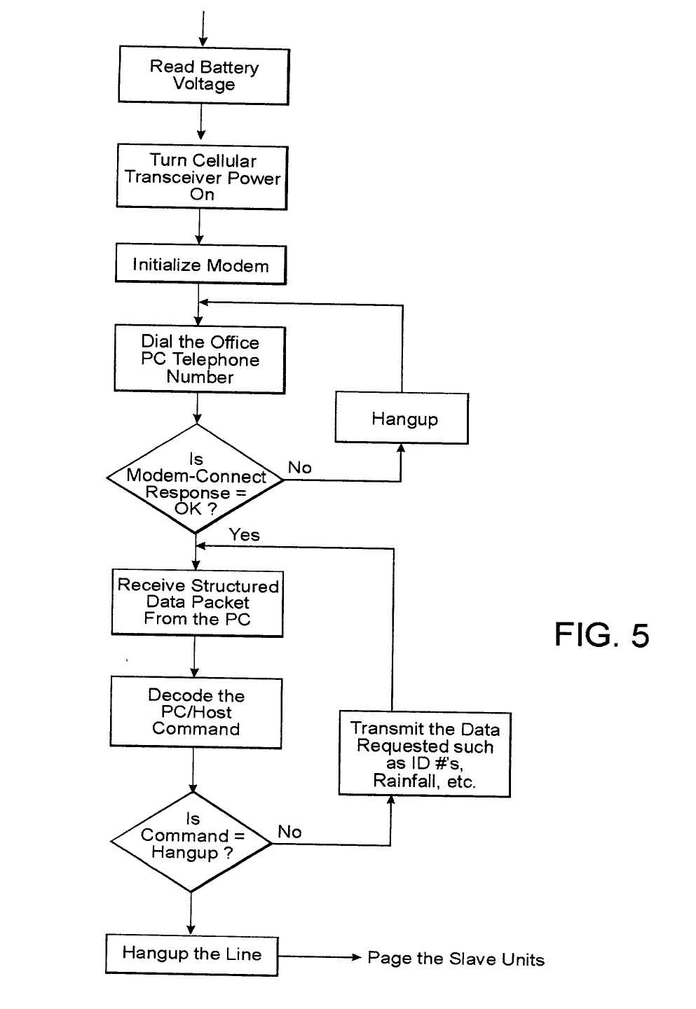

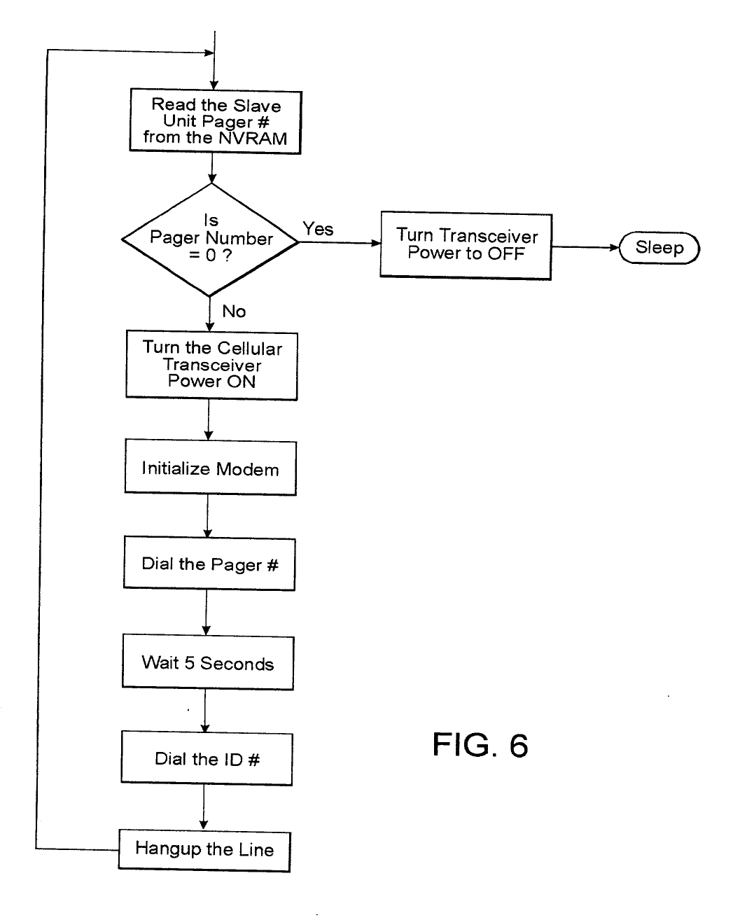

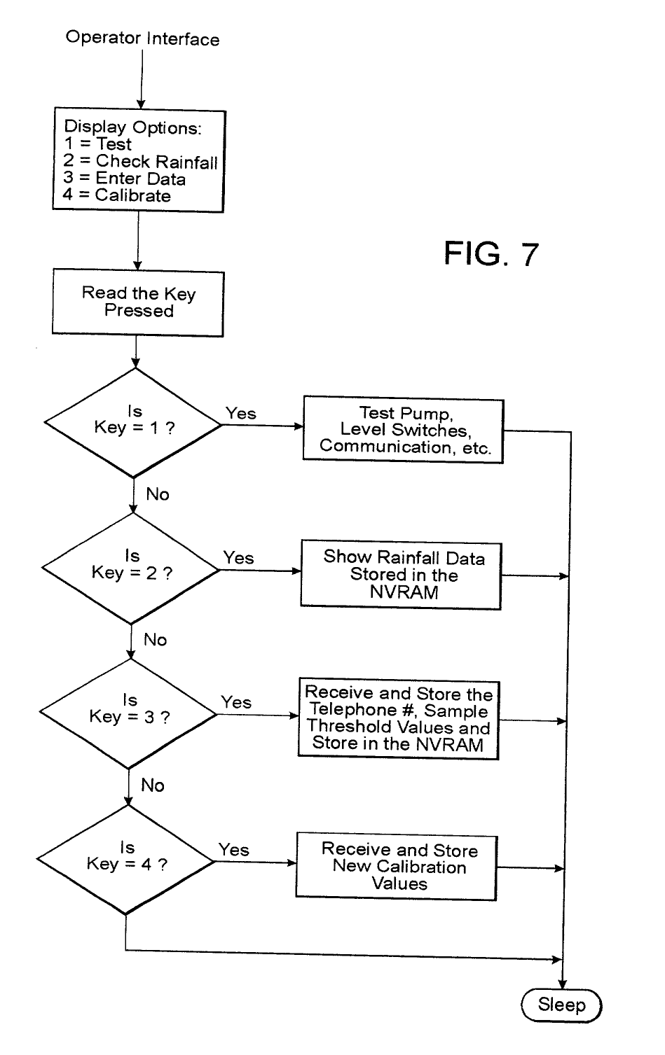

In general the system operates as follows. Upon detection of a selected amount of rainfall by the rain gauge, the pump is energized to draw stormwater runoff. However, this is only done if the water sensor adjacent the collection end of the hose confirm the presence of water. The pump pumps the stormwater into the sample bottle for a predetermined time (set by using terminal) or until the bottle is sensed to be full. Upon sensing a full state the pump is disengaged and a radio signal is emitted by the cellular transceiver to a remote off-site monitoring station. That station may then dispatch a worker to collect the specimen from the sample bottle. An example of specific software programmed operation for the CPU in executing this operation is shown in FIGS. 3-7.

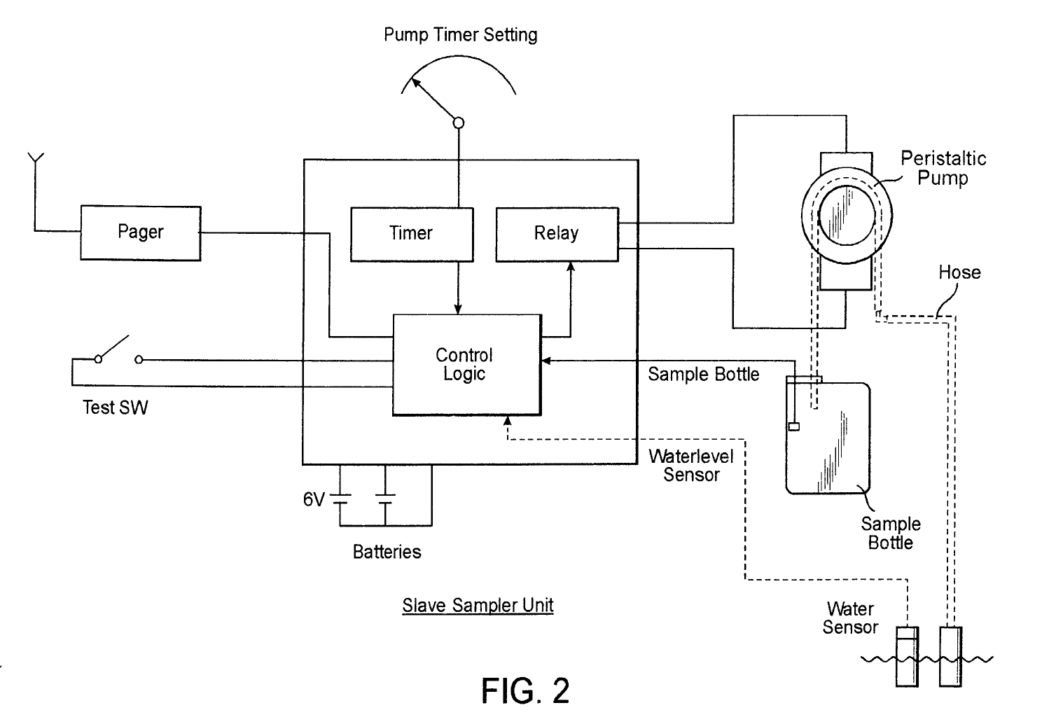

For large construction sites the just described system is termed a master unit to which one or more slave units may be controlled. A preferred slave unit is shown in FIG. 2. It is of relatively simple and economic construction. It has a pump that pumps runoff water into a sample bottle as before. It has computer control logic powered by a battery pack and a simple pager. Upon receipt of a signal from the master unit or off-site station its control logic turns on the pump through a relay, provided again that water is sensed at the collection site. The pump operates for a preselected period of time or until the sample bottle is sensed to be full. The slave unit thus serves to collect a specimen upon receipt of a signal from the master unit. One construction site may be equipped with a number of these slave units.

It thus is seen that an automated stormwater monitoring system and method is now provided that alleviates problems long associated with those of the prior art. It provides for very cost efficient monitoring. Although the invention has been shown and described in its preferred forms, it should be understood that many additions, deletions and modifications may be made thereto without departure from the scope of the invention as described in the following claims.

1. An automated stormwater monitoring system comprising means for detecting onsite rainfall at a construction site, means for collecting a specimen of rainfall runoff in response to the detection of a selected level of onsite rainfall; and means for signaling an offsite station that an event has occurred whereby the offsite station may dispatch a courier to the site to collect the specimen for analysis.

2. The monitoring system of claim 1 further comprising means for generating an on-site master activate signal in response to the detection of the selected level of onsite rainfall, and at least one slave unit that has a slave radio receiver and means for collecting a specimen of rainfall runoff in the environ of the slave unit in response to the receipt of a master radio signal by the slave radio receiver.

3. A method of monitoring stormwater runoff at a construction site which comprises the steps of detecting rainfall on site at the construction site; collecting a specimen of stormwater runoff at the construction site in response to the detection of rainfall of a selected amount; and signaling to an offsite monitoring station that a monitoring event has occurred at the construction site.

4. The method of claim 3 wherein the monitoring station is signaled that rainfall has been detected of the preselected amount.

5. The method of claim 3 wherein the monitoring station is signaled that a specimen of stormwater runoff has been collected at the construction site.

6. A method of monitoring stormwater runoff at a construction site which comprises the steps of detecting rainfall on-site at a master station, in response to the detection of rainfall transmitting a signal from the master station to at least one on-site slave station, collecting a specimen of stormwater runoff at the slave station, and signaling to an offsite monitoring station that a monitoring event has occurred.
